(19) United States
(12) Patent Application Publication
(10) Pub. No.: US 2024/0373154 A1
(43) Pub. Date: Nov. 7, 2024

(54) AUTO NEGOTIATION OVER OPTICS

(71) Applicant: MELLANOX TECHNOLOGIES, LTD., Yokneam (IL)

(72) Inventor: Zvi Rechtman, Petah-Tikva (IL)

(21) Appl. No.: 18/631,846

(22) Filed: Apr. 10, 2024

Related U.S. Application Data
(60) Provisional application No. 63/463,469, filed on May 2, 2023.

(51) Int. Cl. H04Q 11/00; H04L 1/00

(52) U.S. Cl. CPC H04Q 11/0071; H04L 1/0057; H04Q 2213/13567

(57) ABSTRACT

Networking devices and optical communication systems are provided. In one example, a system is described to include a first physical coding sublayer (PCS) block that incorporates auto-negotiation information into a control block. The control block is transmitted to a second PCS block and the auto-negotiation information is used to enable negotiation between the first and the second PCS blocks.

### FIELD OF THE DISCLOSURE

The present disclosure is generally directed toward networking and, in particular, toward optical networks and communications.

### BACKGROUND

Switches and similar networking devices represent a core component of many communication, security, and computing networks. Switches are often used to connect multiple devices to form networks.

Optical networking utilizes a communication system equipped with optical fiber technology. Optical fiber technology utilizes optical fiber cables and light as a primary mechanism for converting and passing data and voice communication across a network.

### BRIEF SUMMARY

Embodiments of the current disclosure are directed to enabling auto-negotiation between two physical layers (PHYs) in an optical network using physical coding sublayers (PCSs). The PCS is a networking protocol sublayer defined in the IEEE 802.3 standards for 1G Ethernet to 1.6 T Ethernet and other Ethernet standards (e.g., Fast Ethernet, Gigabit Ethernet, and 10 Gigabit Ethernet standards). It resides at the top of the physical layer (PHY), and provides an interface between the physical medium attachment (PMA) sublayer and the media-independent interface (MII).

Enabling auto-negotiation between the PCSs involved in a communication link can help improve network performance, among other advantages. In some embodiments, the 64/66 order set may be defined to carry auto-negotiation information.

Example aspects of the present disclosure provide a system, including: a first PCS block that incorporates auto-negotiation information into a control block, where the control block is transmitted to a second PCS block and where the auto-negotiation information is used to enable negotiation between the first and the second PCS blocks.

In some aspects, the control block is transparent to a digital signal processor data path.

In some aspects, the negotiation between the first and the second PCS blocks is transparent to a PMA sublayer and a physical medium dependent (PMD) sublayer.

In some aspects, the control block is transmitted to the second PCS block via an optical signal.

In some aspects, the first PCS block is part of a transmitter device in a communication network, and the transmitter device further includes a management data Input/Output (MDIO) register primitive that selectively bypasses or enables an inner-forward error correction (FEC) between the first PCS block and the second PCS block.

In some aspects, the control block includes an Optical Auto Negotiation (OAN) field and an OAN page.

In some aspects, the OAN page includes one or more protocol handshake variables.

In some aspects, the first PCS block and the second PCS block follow an auto-negotiation protocol in which at least one of a link status check and a transmit disable step are omitted.

In another illustrative example, a networking device is described to include: an optical network interface; and a PCS block to: transmit and/or receive optical data signals via the optical network interface; and perform auto-negotiation with another networking device via the optical network interface.

In some aspects, the auto-negotiation is performed by exchanging optical symbols with the another networking device.

In some aspects, the auto-negotiation is performed at a nominal communication rate that is also used to exchange the optical data signals via the optical network interface.

In some aspects, the auto-negotiation is performed at approximately a same speed with which the optical data signals are transmitted and/or received.

In some aspects, an auto-negotiation state machine is included in the PCS block.

In some aspects, the optical network interface comprises an Ethernet interface.

In some aspects, the networking device further includes an FEC unit that locks a communication link with the another networking device.

In another example, an optical communication system is described to include: at least one communication node comprising an optical transceiver and a PCS block to perform auto-negotiation with another communication node in the optical communication system via the optical transceiver.

In some aspects, the PCS block incorporates auto-negotiation information into a control block transmitted to the another communication node.

In some aspects, the auto-negotiation information includes one or more FEC fields.

In some aspects, the one or more FEC fields indicate an inner-FEC bypass logic and/or a convolutional interleaver logic to be used for a communication link established with the another communication node.

In some aspects, the auto-negotiation is performed at a nominal communication rate that is also used to exchange optical data signals via the optical transceiver.

Additional features and advantages are described herein and will be apparent from the following description and the figures.

### BRIEF DESCRIPTION OF THE SEVERAL VIEWS OF THE DRAWINGS

The present disclosure is described in conjunction with the appended figures, which are not necessarily drawn to scale:

FIG. 1 is a block diagram depicting an illustrative communication system in accordance with at least some embodiments of the present disclosure;

FIG. 2 is a block diagram depicting additional details of an illustrative communication system in accordance with at least some embodiments of the present disclosure;

FIG. 3 is a block diagram depicting a data structure used in accordance with at least some embodiments of the present disclosure;

FIG. 4 is a block diagram depicting additional details of a data structure used in accordance with at least some embodiments of the present disclosure;

FIG. 5A is a block diagram depicting a first step of a first negotiation process in accordance with at least some embodiments of the present disclosure;

FIG. 5B is a block diagram depicting additional steps of a first negotiation process in accordance with at least some embodiments of the present disclosure;

FIG. 6A is a block diagram depicting a first step of a second negotiation process in accordance with at least some embodiments of the present disclosure;

FIG. 6B is a block diagram depicting a first set of additional steps of a second negotiation process in accordance with at least some embodiments of the present disclosure;

FIG. 6C is a block diagram depicting a second set of additional steps of a second negotiation process in accordance with at least some embodiments of the present disclosure;

FIG. 7A is a block diagram depicting a first step of a third negotiation process in accordance with at least some embodiments of the present disclosure;

FIG. 7B is a block diagram depicting additional steps of a third negotiation process in accordance with at least some embodiments of the present disclosure; and

FIG. 8 is a flow diagram depicting a method in accordance with at least some embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It is understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a printed circuit board (PCB), or the like.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “automatic” and variations thereof, as used herein, refers to any appropriate process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “determine,” “calculate,” “compute,” and variations thereof, as used herein, are used interchangeably, and include any appropriate type of methodology, process, operation, or technique.

Various aspects of the present disclosure will be described herein with reference to drawings that are schematic illustrations of idealized configurations.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

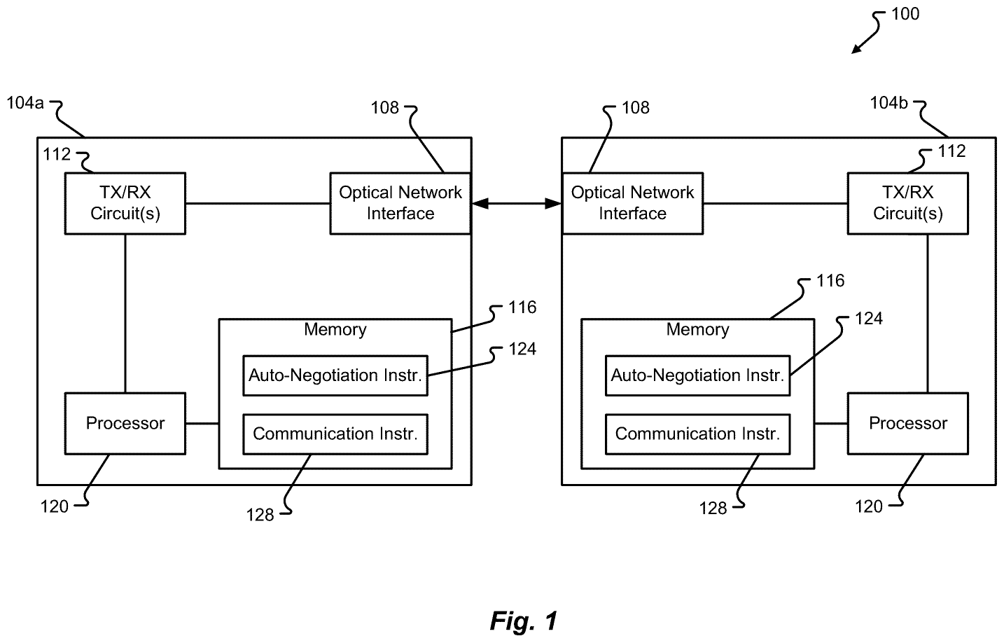

Referring now to FIGS. 1-8, various systems and methods for communicating data between networking devices will be described. Communications between networking devices or within a communication system may include a phase in which the networking devices involved in a communication link negotiate aspects or parameters of communications to be carried out between the networking devices (e.g., over the communication link). Once the negotiation phase has completed, the communication link is established between the networking devices and the exchange of data may be facilitated using the negotiated aspects or parameters.

An Ethernet technique known as “auto-negotiation” enables two connected devices to select standard transmission characteristics such as duplex mode, speed, precoding, FEC, and flow control. Problematically, however, existing auto-negotiation techniques are not carried out over an optical network interface (e.g., an 802.3 optical network interface). Thus, a communication link separate from the optical communication link is required to facilitate the auto-negotiation. Embodiments of the present disclosure aim to address these shortcomings by providing an improved auto-negotiation approach that can be carried out over an optical network interface that is used for exchanging data, thereby avoiding the need for an additional communication link dedicated to auto-negotiation.

The concepts of auto-negotiation and communication described herein can be applied to the routing of information from one computing device to another. The term packet as used herein should be construed to mean any suitable discrete amount of digitized information. The data being routed as part of the auto-negotiation or following completion of the auto-negotiation may be in the form of a single packet or multiple packets without departing from the scope of the present disclosure.

As illustrated in FIG. 1, a communication system 100 may include two or more networking devices 104a, 104b, configured to exchange information electronically with one another. In some embodiments, the communication system 100 may include more than two networking devices 104a, 104b. The networking devices 104a, 104b may be connected to one another directly or through a larger communication network (e.g., an Ethernet network or similar set of devices implementing a communication protocol like the Ethernet protocol). It should also be appreciated that the networking devices 104a, 104b may be configured to communication with one another using a protocol other than the Ethernet protocol. Further still, embodiments of the present disclosure may be utilized in any suitable or yet-to-be-developed type of Ethernet protocol (e.g., 10 Mbit/s Ethernet, Fast Ethernet, Gigabit Ethernet, 2.5 Gigabit Ethernet, 5 Gigabit Ethernet, 10 Gigabit Ethernet, 25 Gigabit Ethernet, 40/100 Gigabit Ethernet, or the like).

The networking devices 104a, 104b may be of the same type or different types. Illustrative but non-limiting examples of networking devices 104a, 104b include endpoint devices (e.g., user devices, mobile devices, Personal Computers (PCs), laptops, tablets, etc.), nodes, switches, servers, routers, gateways, network cards, Network Interface Controllers (NICs), or the like. The first networking device 104a may be a first type of networking device whereas the second networking device 104b may be a second type of networking device. Alternatively, the first networking device 104a and the second networking device 104b may be a common type of networking device.

While the first networking device 104a and second networking device 104b are illustrated as having similar components, it should be appreciated that the components of the first networking device 104a do not have to match the components of the second networking device 104b. In some embodiments, for example, the first networking device 104a may have a first set of components enabling a first set of communication capabilities whereas the second networking device 104b may have a second set of components enabling a second set of communication capabilities. Because the communication capabilities of the first networking device 104a and the second networking device 104b may not necessarily be the same, the networking devices 104a, 104b may be provided with an ability to negotiate communication settings or parameters prior to exchanging data. In some embodiments, the first networking device 104a and/or the second networking device 104b may be provided with auto-negotiation instructions 124 stored in memory 116. When executed by the processor 120, the auto-negotiation instructions 124 may enable one networking (e.g., the first networking device 104a) to perform an auto-negotiation protocol/process with the other networking device (e.g., the second networking device 104b).

As will be described in further detail herein, the networking devices 104a, 104b may perform auto-negotiation over an optical network interface 108. The auto-negotiation process may result in the networking devices 104a, 104b agreeing upon communication settings or parameters to use for the exchange of data (e.g., packets) over the same optical network interface 108. The communication settings or parameters may then be shared with communication instructions 128, which are also stored in memory 116. The communication instructions 128, when executed by the processor 120, may then enable the networking devices 104a, 104b to communicate with one another via the optical network interface 108.

In some embodiments, the auto-negotiation instructions 124 may enable one networking device to exchange optical symbols with the other networking device as part of the auto-negotiation process. In some embodiments, the auto-negotiation may be performed at a nominal communication rate that is also used to exchange the optical data signals via the optical network interface 108. Said another way, the auto-negotiation may be performed at approximately the same speed with which optical data signals will eventually be transmitted and/or received by the networking device 104a, 104b. In some embodiments, the auto-negotiation instructions 124 may also include a state machine that is provided in a PCS block of the networking device 104a, 104b. Advantageously, the auto-negotiation instructions 124 may enable auto-negotiation over the same optical network interface 108 that is used for data exchange, thereby obviating the need for an additional network interface to facilitate auto-negotiation as compared to data exchange.

FIG. 1 also illustrates the optical network interface 108 being coupled with the processor 120 via one or more transmission/receiver (TX/RX) circuits 112. While illustrated as being separate from the processor 120, it should be appreciated that the TX/RX circuits 112 may be included with the processor 120 or the processor 120 may be provided as part of the TX/RX circuits 112.

As can be appreciated, the networking devices 104a, 104b may be capable of receiving, processing, and transmitting data, e.g., packets, to appropriate destinations within communication system 100. For instance, the networking devices 104a, 104b may be configured to exchange data with one another or with other switches or other network endpoints network endpoints. The optical network interface 108, TX/RX circuit(s) 112, processor 120, and communication instructions 128 may be configured to facilitate the exchange of data according to communication settings or parameters negotiated by the auto-negotiation instructions 124.

The optical network interface 108 may include, for example an Ethernet interface or similar type of communication interface. For instance, the optical network interface 108 may include one or more devices that convert electrical signals into optical signals (e.g., for transmitting data) or that convert optical signals into electrical signals (e.g., for receiving data). While embodiments will be described in connection with an optical network interface 108 including an Ethernet interface (e.g., an Ethernet port), it should be appreciated that the optical network interface 108 may include any suitable type of optical device or collection of devices that facilitates machine-to-machine communications with optical signals.

The TX/RX circuit(s) 112 may include any combination of analog and/or digital circuit components. As will be described in further detail herein, the TX/RX circuit(s) 112 may include circuit components that facilitate the creation of a communication stack within the networking device. Illustratively and without limitation, the TX/RX circuit(s) 112 may include circuit components that create one or more of a PMD sublayer, a PMA sublayer, a PCS block, a Reconciliation Standard (RS) sublayer, a Medium Access Control (MAC) sublayer, or the like. Such circuit components may include resistors, capacitors, inductors, diodes, transistors, or the like.

The processor 120 of the networking device 104a, 104b may include one or more processing circuits and/or a processing unit. Non-limiting examples of a processor 120 include a graphics processing unit (GPU), a central processing unit (CPU), a data processing unit (DPU), an application-specific integrated circuit (ASIC), a field programmable gate array (FPGA), a microprocessor, or other circuit(s) capable of performing computations, as well as memory and storage resources to run software applications, handle data processing, and perform specific tasks as required.

Memory 116 as described herein may comprise one or more memory elements capable of storing configuration settings, routing groups, application data, operating system data, and other data. Such memory elements may include, for example, random access memory (RAM), dynamic RAM (DRAM), flash memory, non-volatile RAM (NVRAM), ternary content-addressable memory (TCAM), static RAM (SRAM), and/or memory elements of other formats.

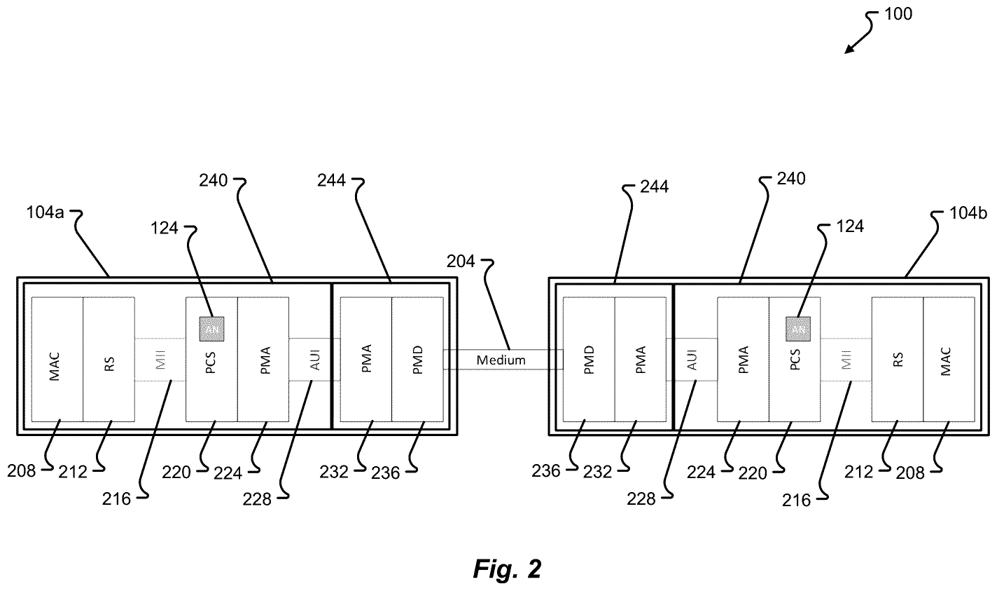

Referring now to FIG. 2, additional components of the networking devices 104a, 104b will be described in further detail. Specifically, FIG. 2 illustrates details of the TX/RX circuit(s) 112 and the functional blocks that are used to facilitate the auto-negotiation and/or data exchange between networking devices 104a, 104b. Illustratively, but without limitation, one or both networking devices 104a, 104b may include a MAC sublayer 208, an RS sublayer 212, a PCS block 220, a first PMA sublayer 224, a second PMA sublayer 232, and a PMD sublayer 236. The RS sublayer 212 may be connected to the PCS block 220 via a Media Independent Interface (MII) 216. The first PMA sublayer 224 may be connected to the second PMA sublayer 232 via an Attachment Unit Interface (AUI) 228.

The MAC sublayer 208 be configured to provide control capabilities for the optical network interface 108. In some embodiments, the MAC sublayer 208 may be a part of the data link layer that provides flow control and multiplexing for the transmission medium.

The RS sublayer 212 may be configured to process PHY local and/or remote fault messages. The RS sublayer 212 may also be configured to handle DDR conversions.

The PCS block 220 may be provided between the MII 216 and the first PMA sublayer 224. The PCS block 220 may be configured to provide an interface between the MII 216 and the first PMA sublayer 224 and may be responsible for data encoding, decoding, scrambling, and descrambling. The PCS block 220 may also be configured to provide alignment marker insertion and removal, block and symbol redistribution, FEC encoding and decoding, and lane block synchronization and deskew. In some embodiments, and as will be described in further detail herein, the PCS block 220 may be provided with auto-negotiation instructions 124. The auto-negotiation instructions 124 may enable the PCS block 220 to perform various auto-negotiation processes or functions over the optical network interface 108.

The PMA sublayers 224, 232 may be provided on both sides of the AUI 228. In some embodiments, the PMA sublayers 224 may be configured to provide a number of functions. Non-limiting examples of such functions include: adapting the PCSL/FECL-formatted signal to the appropriate number of abstract or physical lanes; providing per-input-lane clock and data recovery; providing bit-level or RS-symbol multiplexing; providing clock generation; providing signal drivers; providing local loopback; providing remote loopback; providing test-pattern; tolerating Skew Variation; performing PAM<n> encoding and decoding, including Gray mapping and optional precoding, when required; PMA framing, octet synchronization, octet detection, scrambling, descrambling capabilities.

The PMD sublayer 236 may be provided between the second PMA sublayer 232 and the physical medium 204. The PMD sublayer 236 may include or provide a transceiver for the physical medium. For instance, the PMD sublayer 236 may define the physical layer and handle the details of transmission and reception of individual bits on the physical medium 204. For instance, the PMD sublayer 236 may be configured to provide bit timing, signal encoding, and other functions related to interacting with the physical medium 204.

The MII 216 may be configured to connect the RS sublayer 212 to the PCS block 220. In some embodiments, the MII 216 may also have a number of registers to support the exchange of information between the RS sublayer 212 and the PCS block 220. The MII 216 may also include an MDIO register primitive that selectively bypasses or enables inner-Forward Error Correction (FEC). In some embodiments, the inner-FEC may occur over the optical channel between the two PHYs, where the PCS blocks 220 are a sublayer in a PHY.

The AUI 228 may be configured to connect the first PMA sublayer 224 and the second PMA sublayer 232. The AUI 228 may include a physical and logical interface to connect the sublayers 224, 232.

As mentioned above, the PCS block 220 of each networking device 104a, 104b may include auto-negotiation instructions 124. The auto-negotiation instructions 124 may enable the PCS block 220 of the first networking device 104a to negotiate with the PCS block 220 of the second networking device 104b. In some embodiments, the auto-negotiation may be transparent to a digital signal processor data path. The auto-negotiation between the PCS blocks 220 may also be transparent to the PMA sublayers 224, 232 and the PMD sublayers 236 of each networking device 104a, 104b. As shown, the PMA sublayer 232 and PMD sublayer 236 may be included as part of an optical transceiver 244 whereas other components (e.g., MAC 208, RS 212, PCS 220, and PMA sublayer 224) may be included as part of device hardware 240. Advantageously, the solutions depicted and described herein do not require any significant changes to the functional operations of the existing optical transceivers 244. The auto-negotiation instructions 124 may enable the PCS block 220 of the first networking device 104a to incorporate auto-negotiation information into a control block that is transmitted to the PCS block 220 of the second networking device 104b. The control block may include an Optical Auto Negotiation (OAN) field and an OAN page, as will be described in further detail herein. The OAN page may include one or more protocol handshake variables.

The auto-negotiation information exchanged between the PCS blocks 220 facilitates the negotiation of communication settings or parameters to be used by the communication instructions 128 of the networking devices 104a, 104b. The auto-negotiation information may include one or more FEC fields that indicate an inner-FEC bypass logic and/or a convolutional interleaver logic to be used for a communication link established between the networking devices 104a, 104b. The auto-negotiation information may also include one or more fields to support precoding or any other logical features supported by the optical transceiver 244. In some embodiments, the PCS blocks 220 may follow an auto-negotiation protocol in which at least one of a PMD control function (e.g., link training, PMD startup protocol, etc.) and a transmit disable step are omitted. The link status check and transmit disable steps are commonly used in traditional Ethernet negotiations involving a separate electrical interface, but because the auto-negotiation protocol is being carried out over the optical network interface 108, PMD control function and transmit disable steps can be omitted.

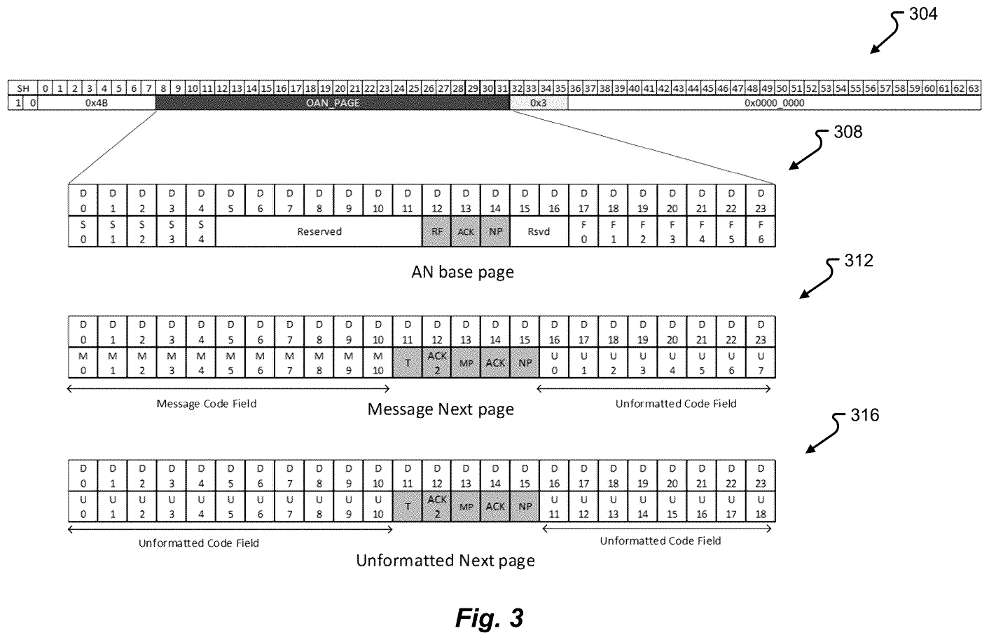

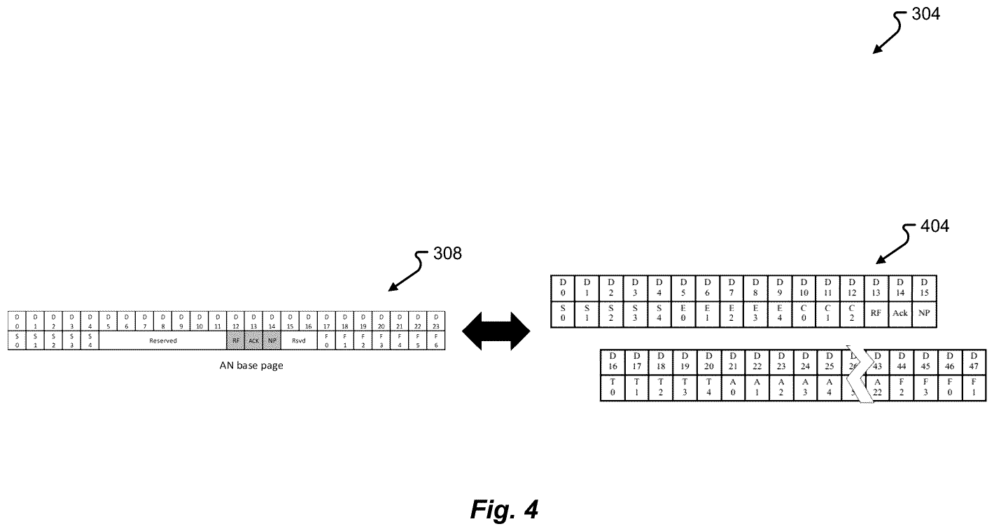

Referring now to FIGS. 3 and 4, additional details regarding the control block 304 and the content thereof used to facilitate auto-negotiation over the optical network interface 108 will be described in accordance with at least some embodiments. FIG. 3 illustrates details of an example control block 304 in which an OAN page is provided. There may be various types of OAN pages that are used at part of the control block 304. The size of the OAN page may be any suitable size, but the examples illustrated herein correspond to an OAN page having a size of 24 bits or 48 bits.

The examples of OAN pages illustrated in FIG. 3 include an OAN base page 308, an OAN Message Next page 312, and an OAN Unformatted Next page 316. It should be appreciated that the OAN page can include different formats, handshake variables, or fields without departing from the scope of the present disclosure. The OAN base page 308 may include Clause 73 protocol handshake variables (e.g., RF, ACK, NP, etc.) for the AN base page example. Additional details of Clause 73 are described in IEEE 802.3, the entire contents of which are hereby incorporated herein by reference. The OAN Message Next page 312 may follow the Clause 73 protocol and utilize the same variables therein (e.g., T, ACK 2, MP, ACK, NP, etc.). The OAN Unformatted Next page 316 may also utilize the variables defined in Clause 73, but may be 48 bits.

As can be seen in FIG. 4, links 304 may be established between an OAN page (e.g., the OAN base page 308) and a link codeword base page 404. The link codeword base page 404 is illustrated to have 16 data positions, but fewer or greater data positions may be used without departing from the scope of the present disclosure.

In some embodiments, the OAN base page 308 may include handshake variables RF, ACK, and NP. It may not be necessary to define parameters such as E, C, T, and A since the auto-negotiation is occurring over the optical network interface 108. As mentioned above, new F parameters in the link codeword base page 404 may be provided for inner-FEC control. In some embodiments, the FEC fields may include an F0 field, an F1 field, an F2 field, and an F3 field. These fields may support defining an inner-FEC bypass logic and a convolutional interleaver logic.

The F0 field may define whether the networking device supports inner-FEC Hamming (128, 120) bypass and can be set as “1” for a compliant device. The F1 field may define whether inner-FEC Hamming (128, 120) bypass will be used. The F2 field may define whether the networking device supports an N-way convolutional interleaver (e.g., where N=12, N=6, N=4, etc.). The F3 field may define whether 12-way convolutional interleaver is enabled. The inner-FEC bypass logic may be defined as (LP.F0 AND RP.F0) AND (LP.F1 OR RP.F1). The convolutional interleaver logic may be defined as (LP.F2 AND RP.F2) AND (LP.F3 OR RP.F3). There may also be a number of bits reserved for future cases.

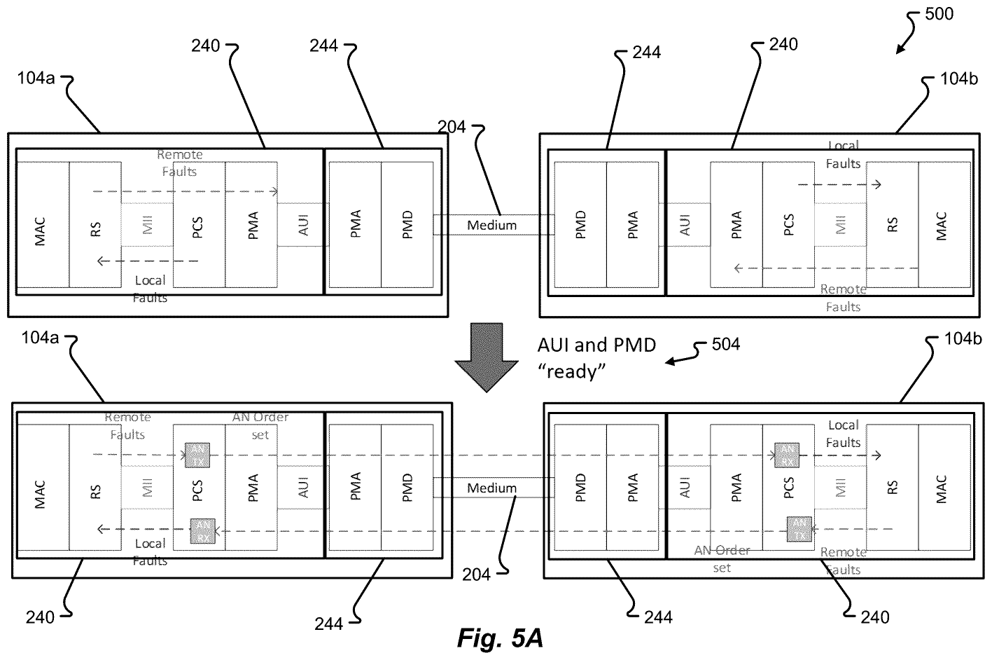

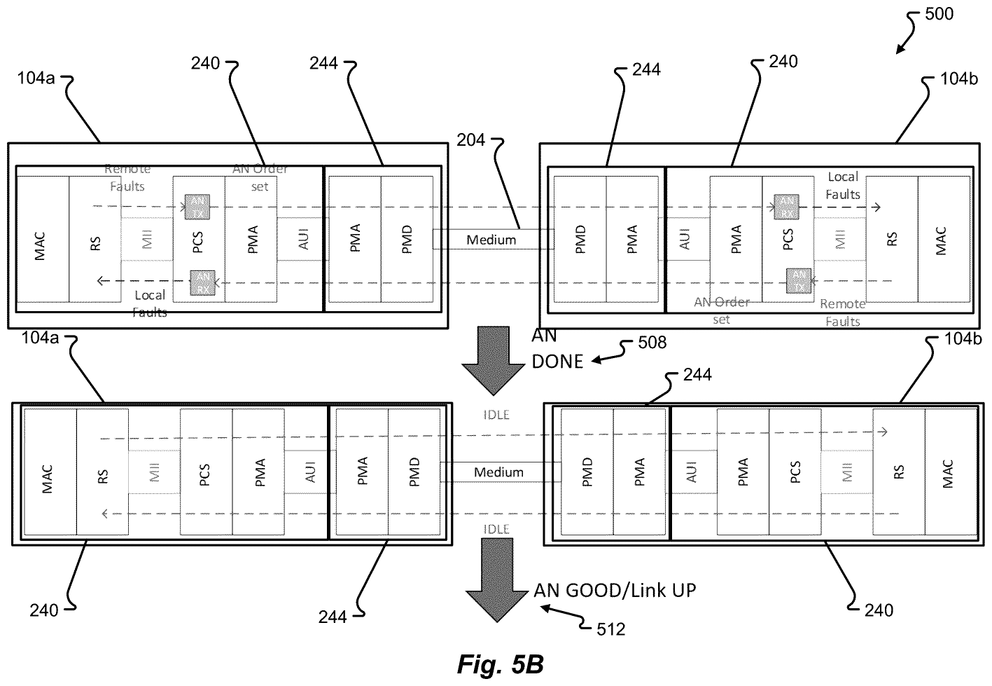

Referring now to FIGS. 5A and 5B, a first example 500 of an auto-negotiation and link-up process will be described in accordance with at least some embodiments of the present disclosure. The first auto-negotiation example 500 illustrates auto-negotiation between the first networking device 104a and second networking device 104b that starts with each networking device 104a, 104b determining remote faults and local faults. Thereafter, the AUI 228 and PMD sublayer 236 of each networking device 104a, 104b are indicated as ready (step 504). An indication of ready may suggest that they AUI 228 and PMD sublayers 236 of each networking device 104a, 104b have completed any required form of calibration and/or equalization without awareness to the fact that the auto-negotiation is occurring between the PCS blocks 220.

The PCS block 220 of the first networking device 104a then transmits an AN Order set (e.g., auto-negotiation information in a control block) to the PCS block 220 of the second networking device 104b. In response thereto or concurrent therewith, the PCS block 220 of the second networking device 104b transmits an AN Order set (e.g., auto-negotiation information in a control block) to the PCS block 220 of the first networking device 104a. The exchange of auto-negotiation information between the networking devices 104a, 104b enables the PCS blocks 220 of the networking devices 104a, 104b to negotiate communication settings or parameters. Once auto-negotiation information has been exchanged and the auto-negotiation instructions 124 of each networking device 104a, 104b has applied the appropriate logic thereto, the auto-negotiation is completed (step 508). Confirmation that auto-negotiation is completed results in the establishment of a communication link (step 512) between the first networking device 104a and the second networking device 104b according to the communication settings or parameters defined during auto-negotiation.

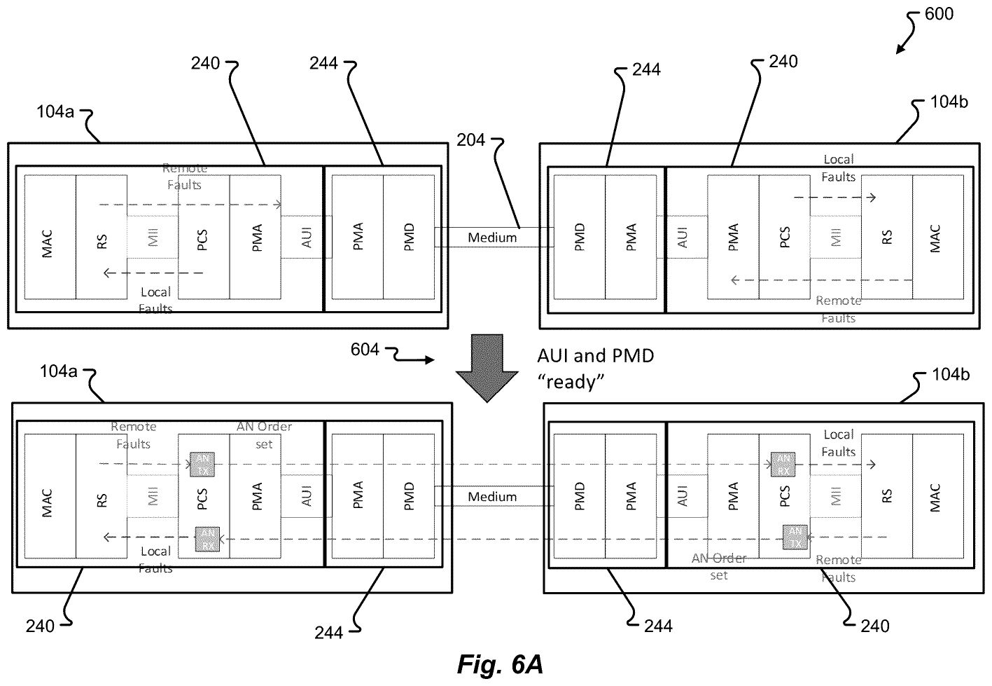

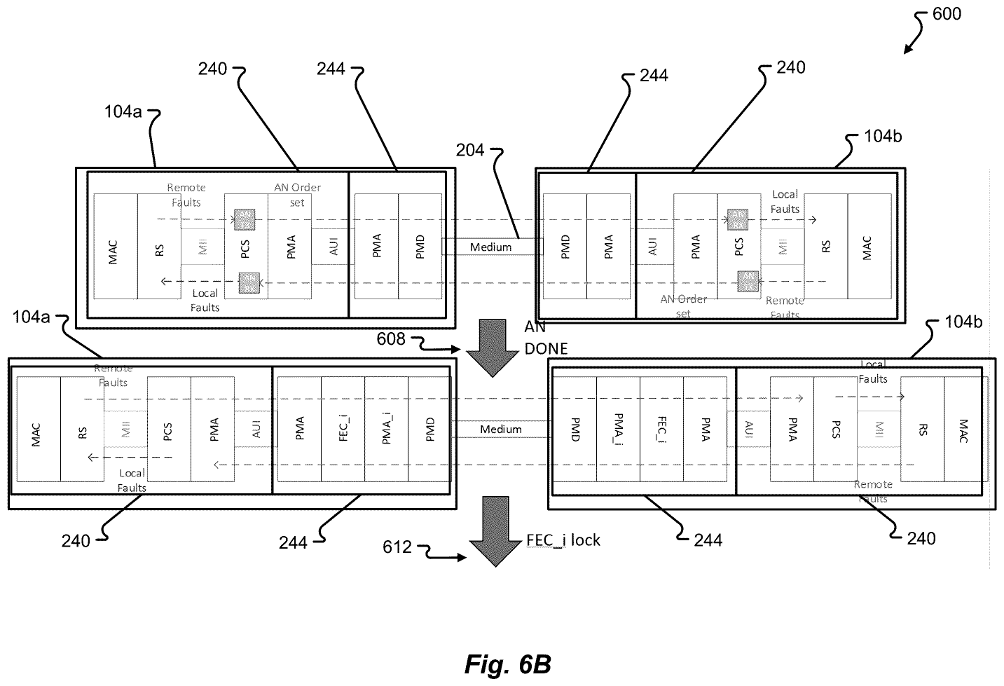

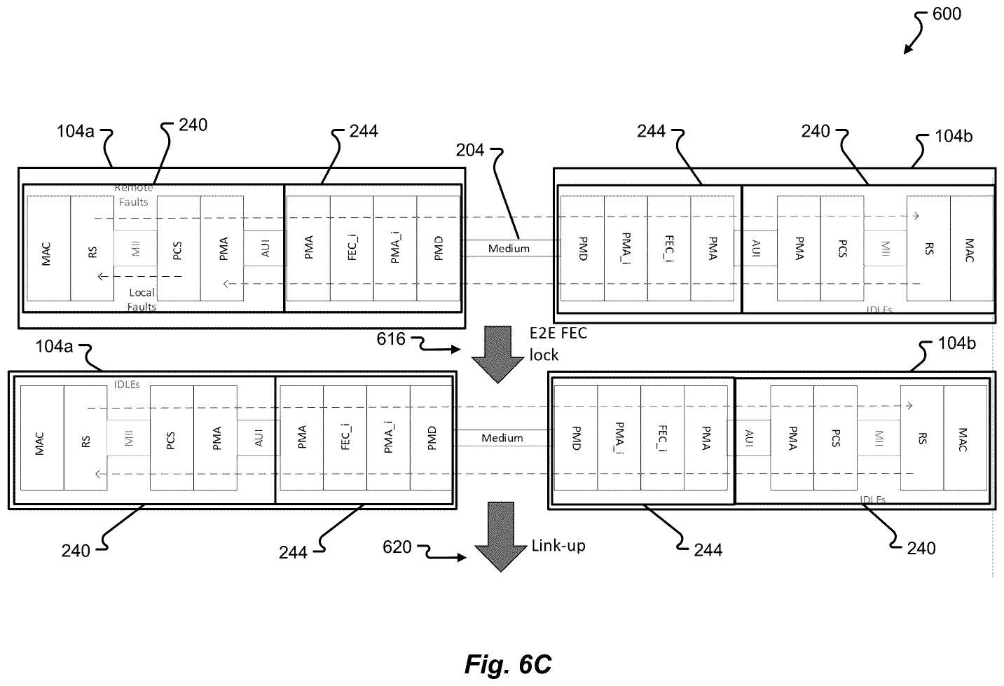

Referring now to FIGS. 6A through 6C, a second example 600 of an auto-negotiation and link-up process will be described in accordance with at least some embodiments of the present disclosure. The second auto-negotiation example 600 illustrates auto-negotiation between the first networking device 104a and second networking device 104b that starts with each networking device 104a, 104b determining remote faults and local faults. Thereafter, the AUI 228 and PMD sublayer 236 of each networking device 104a, 104b are indicated as ready (step 604).

The PCS block 220 of the first networking device 104a then transmits an AN Order set (e.g., auto-negotiation information in a control block) to the PCS block 220 of the second networking device 104b. In response thereto or concurrent therewith, the PCS block 220 of the second networking device 104b transmits an AN Order set (e.g., auto-negotiation information in a control block) to the PCS block 220 of the first networking device 104a. The exchange of auto-negotiation information between the networking devices 104a, 104b enables the PCS blocks 220 of the networking devices 104a, 104b to negotiate communication settings or parameters. Once auto-negotiation information has been exchanged and the auto-negotiation instructions 124 of each networking device 104a, 104b has applied the appropriate logic thereto, the auto-negotiation is completed (step 608).

The second auto-negotiation example 600 further illustrates a process of negotiating FEC. As shown in FIGS. 6B and 6C, the FEC sublayer and PMA sublayer of each networking device 104a, 104b may further perform one-way FEC lock (step 612) and then an End-to-End (E2E) FEC lock (step 616). The one-way FEC lock may be performed with the RS sublayer 212 of one networking device transmitting FEC information to the PCS block 220 of the other networking device. In some embodiments, the networking devices may include an MDIO register primitive or common management interface specification (CMIS) register that selectively bypasses or enables an inner-FEC between the PCS block 220 of the first networking device 104a and the PCS block 220 of the second networking device 104b.

Confirmation that auto-negotiation and FEC lock is completed results in the establishment of a communication link (step 620) between the first networking device 104a and the second networking device 104b according to the communication settings or parameters defined during auto-negotiation. It should be appreciated that FEC could be utilized to improve link resiliency to errors with some penalty of power and latency. For this reason, some solutions may prefer to operate with FEC—to improve resiliency, while other solutions may benefit from not operating with FEC to optimize power and latency.

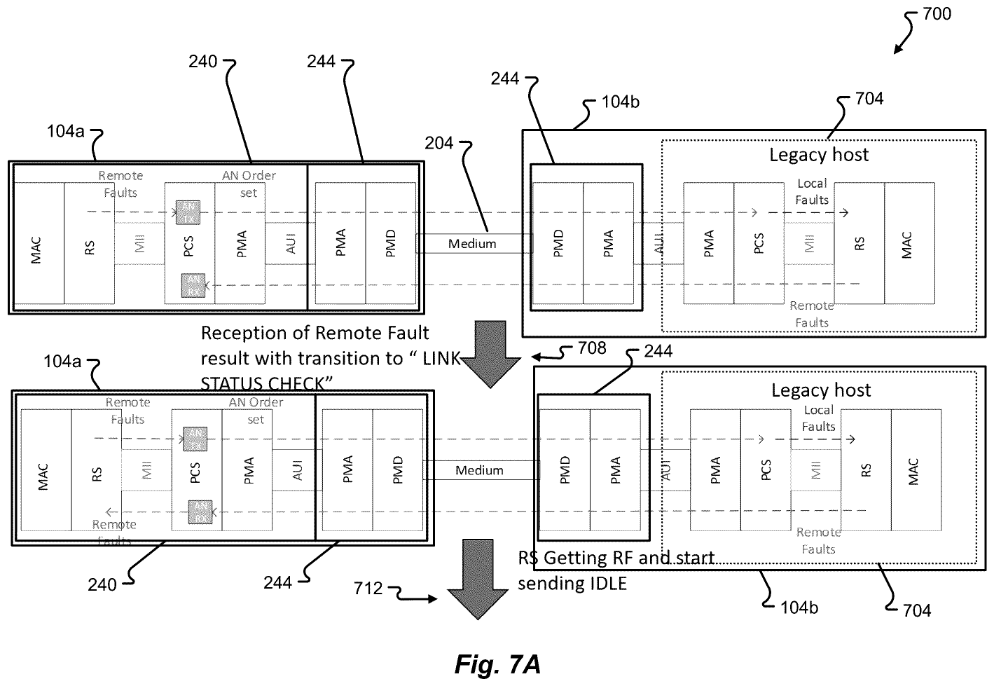

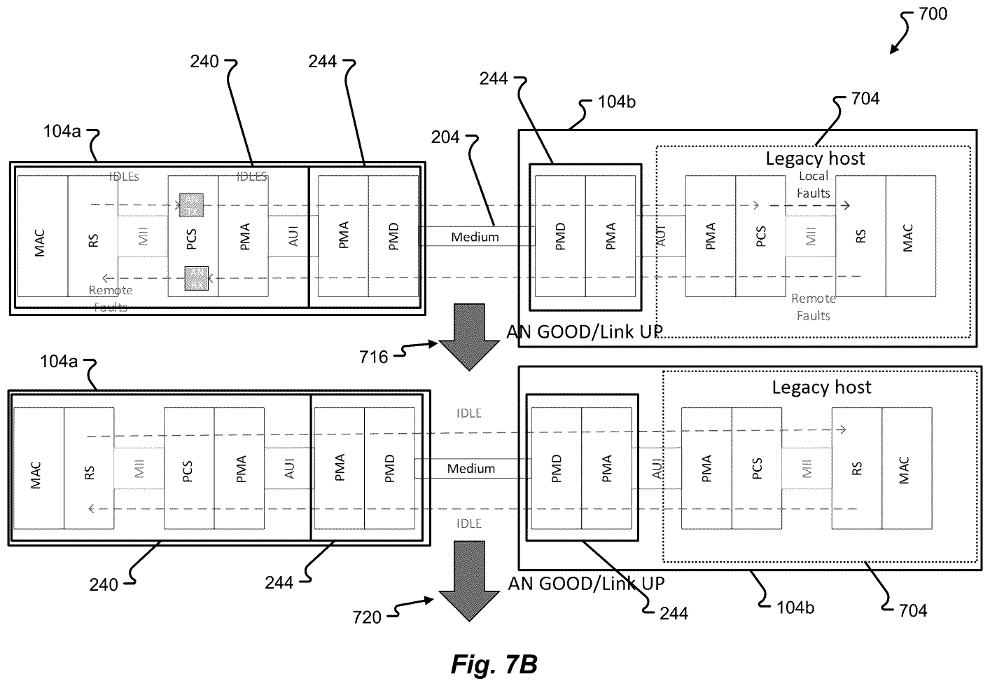

Referring now to FIGS. 7A and 7B, a third example 700 of an auto-negotiation and link-up process will be described in accordance with at least some embodiments of the present disclosure. The third auto-negotiation example 700 illustrates auto-negotiation between the first networking device 104a and second networking device 104b, where the second networking device 104b includes a legacy host 704. The legacy host 704 may include hardware, firmware, or the like that is older than hardware or firmware of the first networking device 104a and, therefore, does not support certain features that would otherwise be available to the first networking device 104a. For instance, the PCS block 220 of the legacy host 704 does not include auto-negotiation instructions 124 or capabilities.

The third auto-negotiation example 700 starts with the PCS block 220 of the first networking device 104a sending an AN Order set to the PCS block 220 of the second networking device 104b. The PCS block 220 of the second networking device 104b sends local faults to the RS sublayer 212 of the second networking device 104b, which then sends remote fault results back to the PCS block 220 of the first networking device 104a. The reception of the remote fault results at the first networking device 104a causes the devices 104a, 104b to enter a link status check state (step 708).

Thereafter, the PCS block 220 of the first networking device 104a transmits the remote fault results to the RS sublayer 212 of the first networking device 104a. In this step, the RS sublayer 212 of the first networking device 104a is receiving the remote fault results of the second networking device 104b and begins sending IDLEs to the legacy host 704 (step 712).

Once auto-negotiation information has been exchanged and the auto-negotiation instructions 124 of the first networking device 104a have determined the appropriate communication settings or parameters to support communications between the networking devices 104a, 104b, the auto-negotiation is completed (steps 716 and 720). In this particular example, there may not actually be auto-negotiation because the legacy host 704 may not be aware of the OAN process. However, this example shows that the link can still be established with some configurations based on the legacy host 704 configuration. In this way, the OAN processes described herein may be backwards compatible with legacy devices, such as legacy host 704.

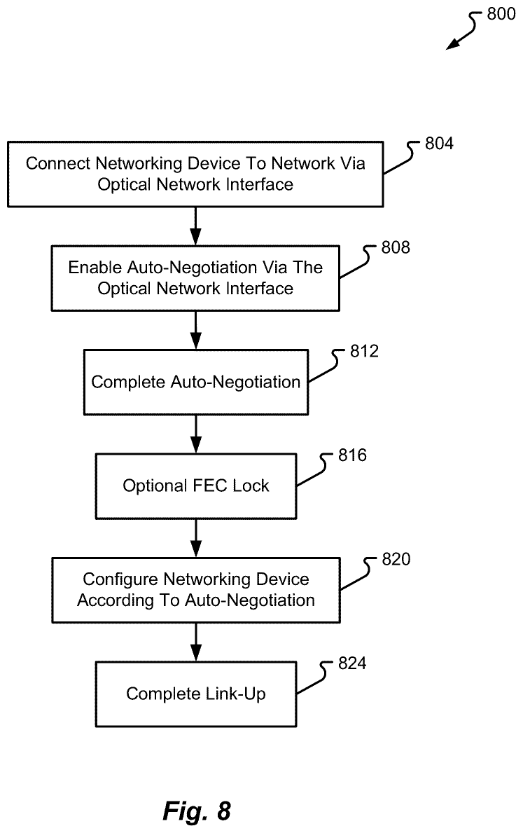

Referring now to FIG. 8, additional details and functions of the systems, networks, and devices will be described in accordance with at least some embodiments of the present disclosure. Various methods will be described with reference to particular elements. It should be appreciated that the steps of some methods may be incorporated into other methods and/or the order of steps of some methods may be changed without departing from the scope of the present disclosure. Additionally, while certain steps are described as being performed by one element, it should be appreciated that other elements may be configured to perform similar or identical steps without departing from the scope of the present disclosure.

Furthermore, the method 800 will be described in accordance with at least some embodiments of the present disclosure. Some or all steps of the method 800 may be performed at a networking device 104a, 104b using some or all components of a networking device 104a, 104b as depicted and described herein.

The method 800 begins by connecting a networking device (e.g., the first networking device 104a) to a network via an optical network interface 108 (step 804). When a networking device is connected to a network (e.g., an Ethernet cable connected to a larger network is physically connected to the networking device), the networking device may begin the process of discovering communication capabilities of other networking devices also connected to the network.

The method 800 may continue by enabling the networking device to perform auto-negotiation with at least one other networking device via the optical network interface 108 (step 808). As described herein, the auto-negotiation process may include the networking device utilizing auto-negotiation instructions 124 and a PCS block 220 to exchange auto-negotiation information with another networking device.

The method 800 continues when auto-negotiation is completed (step 812). The method 800 may also include an optical FEC lock step (step 816). Completion of auto-negotiation and optional FEC lock may result in communication settings or parameters being defined to support a communication link between the networking device and the other networking device with which the auto-negotiation was performed (step 820). In particular, the networking devices involved in the auto-negotiation may configure their communication instructions 128 in accordance with the communication settings or parameters defined during auto-negotiation and the optional FEC lock processes. Once each networking device has appropriately configured their communication instructions 128, the link-up between the networking devices may be completed and data may then be exchanged between the networking devices (step 824). The data may be exchanged over the same optical network interface 108 that was used to facilitate the auto-negotiation. In some embodiments, the auto-negotiation is performed at a nominal communication rate that is also used to exchange the optical data signals via the optical network interface. Said another way, the auto-negotiation is performed at approximately a same speed with which the optical data signals are transmitted and/or received by the networking devices.

It is to be appreciated that any feature described herein can be claimed in combination with any other feature(s) as described herein, regardless of whether the features come from the same described embodiment.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A system, comprising:
a first physical coding sublayer (PCS) block that incorporates auto-negotiation information into a control block, wherein the control block is transmitted to a second PCS block and wherein the auto-negotiation information is used to enable negotiation between the first and the second PCS blocks.

2. The system of claim 1, wherein the control block is transparent to a digital signal processor data path.

3. The system of claim 1, wherein the negotiation between the first and the second PCS blocks is transparent to a Physical Medium Attachment (PMA) sublayer and a Physical Medium Dependent (PMD) sublayer.

4. The system of claim 1, wherein the control block is transmitted to the second PCS block via an optical signal.

5. The system of claim 1, wherein the first PCS block is part of a transmitter device in a communication network, and wherein the transmitter device further comprises a Management Data Input/Output (MDIO) register primitive that selectively bypasses or enables an inner-Forward Error Correction (FEC) between the first PCS block and the second PCS block.

6. The system of claim 1, wherein the control block comprises an Optical Auto Negotiation (OAN) field and an OAN page.

7. The system of claim 6, wherein the OAN page comprises one or more protocol handshake variables.

8. The system of claim 1, wherein the first PCS block and the second PCS block follow an auto-negotiation protocol in which at least one of a link status check and a transmit disable step are omitted.

9. A networking device, comprising:
an optical network interface; and
a physical coding sublayer (PCS) block to:
transmit and/or receive optical data signals via the optical network interface; and
perform auto-negotiation with another networking device via the optical network interface.

10. The networking device of claim 9, wherein the auto-negotiation is performed by exchanging optical symbols with the another networking device.

11. The networking device of claim 9, wherein the auto-negotiation is performed at a nominal communication rate that is also used to exchange the optical data signals via the optical network interface.

12. The networking device of claim 9, wherein the auto-negotiation is performed at approximately a same speed with which the optical data signals are transmitted and/or received.

13. The networking device of claim 9, wherein an auto-negotiation state machine is included in the PCS block.

14. The networking device of claim 9, wherein the optical network interface comprises an Ethernet interface.

15. The networking device of claim 9, further comprising a Forward Error Correction (FEC) unit that locks a communication link with the another networking device.

16. An optical communication system, comprising:
at least one communication node comprising an optical transceiver and a physical coding sublayer (PCS) block to perform auto-negotiation with another communication node in the optical communication system via the optical transceiver.

17. The optical communication system of claim 16, wherein the PCS block incorporates auto-negotiation information into a control block transmitted to the another communication node.

18. The optical communication system of claim 17, wherein the auto-negotiation information comprises one or more Forward Error Correction (FEC) fields.

19. The optical communication system of claim 18, wherein the one or more FEC fields indicate an inner-FEC bypass logic and/or a convolutional interleaver logic to be used for a communication link established with the another communication node.

20. The optical communication system of claim 16, wherein the auto-negotiation is performed at a nominal communication rate that is also used to exchange optical data signals via the optical transceiver.
